(19) United States
(12) Patent Application Publication
(10) Pub. No.: US 2020/0337500 A1
(43) Pub. Date: Oct. 29, 2020

(54) COOKING VESSEL WITH AN OPENING FOR DRAINAGE

(71) Applicants: Seana L. Montgomery, McKinney, TX (US); Isaiah Montgomery, McKinney, TX (US)

(72) Inventors: Seana L. Montgomery, McKinney, TX (US); Isaiah Montgomery, McKinney, TX (US)

(21) Appl. No.: 16/394,450

(22) Filed: Apr. 25, 2019

(51) Int. Cl. A47J 37/10

(52) U.S. Cl. CPC A47J 37/108

(57) ABSTRACT

A cooking vessel (e.g., for cooking foodstuffs) comprises and a sidewall extending from the base wall. The base wall comprises a cooking surface configured to transmit heat to the foodstuffs (e.g., the cooking surface is in direct contact with the foodstuffs directly transmit the heat to the foodstuffs). The sidewall comprises at least one opening to drain a liquid from the cooking surface. The at least one opening is adjacent to the cooking surface (e.g., to facilitate drainage of the liquid with at cooking vessel positioned at a relatively low tilt angle). A method comprises providing a cooking vessel having a cooking surface and a sidewall disposed around the cooking surface; and providing an opening in the sidewall adjacent to a cooking surface. The opening is to drain a liquid from the cooking surface.

### TECHNICAL FIELD

This disclosure relates in general to the field of cookware and, more particularly, to cooking vessels including openings for draining liquids.

### BACKGROUND

Cookware such as pans, pots, and/or other cooking vessels are used to cook foodstuffs. Foodstuffs are placed into the cookware for preparation. The foodstuffs can include solid portions and liquid portions. For example, pasta (i.e., solid) may be cooked in oil and/or water (i.e., liquids); fat, water, and combinations thereof (i.e., liquids) may render from meat (solid) during cooking.

### SUMMARY

According to one aspect a cooking vessel comprises a base wall and a sidewall extending from the base wall. The base wall comprises a cooking surface configured to transmit heat to foodstuffs. The sidewall comprises at least one opening adjacent to the cooking surface. The at least one opening is configured to drain a liquid from the cooking surface based on being adjacent to the cooking surface.

According to still another aspect a method comprises providing a cooking vessel having a cooking surface and a sidewall disposed around the cooking surface; and providing an opening in the sidewall adjacent to a cooking surface, wherein the opening is to drain a liquid from the cooking surface.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A, 1B, and 1C illustrate various views of a cooking vessel with an opening for drainage, according to an embodiment of the present disclosure.

FIGS. 2A and 2B illustrate various views of a cooking vessel with multiple openings on multiple sides for drainage, according to an embodiment of the present disclosure.

FIGS. 3A, 3B, and 3C illustrate various views of a cooking vessel with multiple openings for drainage, according to an embodiment of the present disclosure.

FIGS. 4A, 4B, and 4C illustrate various views of a cooking vessel with multiple openings adjacent a handle for drainage, according to an embodiment of the present disclosure.

FIGS. 5A, 5B, and 5C illustrate various views of a cooking vessel with multiple openings in a hollow portion of a wall for drainage, according to an embodiment of the present disclosure.

FIG. 6A illustrates a cooking vessel with multiple openings adjacent to each side of a handle for drainage, according to an embodiment of the present disclosure. FIG. 6B illustrates a door for the multiple openings on the cooking vessel of FIG. 6A.

FIG. 7 illustrates a method for providing a cooking vessel configured to drain liquid, according to an embodiment of the present disclosure.

### DESCRIPTION OF EXAMPLE EMBODIMENTS

### Example Embodiments

Cookware such as pans (e.g., skillets, frying pans, sauté pans, and the like), pots (e.g., Dutch ovens, stock pots, saucepans), and/or other cooking vessels are used to cook (e.g., fry, sauté, roast, braise, sear, boil, or otherwise heat) foodstuffs. Foodstuffs comprising, e.g., solids, liquids, soups, salads, beverages, and the like are placed into the cookware for preparation. Cookware (e.g., a cooking vessel) may comprise a sidewall and base wall a defining cavity in which to receive foodstuffs. The sidewall generally confines the foodstuffs to the bottom surface, which is heated to cook the foodstuffs. Each of the sidewall and the base wall comprise one or more thermally conductive materials (e.g., cast iron, porcelain, aluminum, etc.). Each of the sidewall and the base wall has both an inner surface and an outer surface. The inner surfaces are located within an interior cavity of the cookware. The outer surfaces are located at an exterior of the cookware. In addition, the outer surface of the base wall is a surface to which heat is applied (e.g., from a fire, stovetop, or other heat source) to heat the cookware (and ultimate to cook the foodstuffs). Though the heat is conducted throughout both the base wall and the sidewall, the inner surface of the base wall is, in general, a surface upon which the foodstuff cooks (i.e., a cooking surface). The cooking surface may be flat, sloped (e.g., to drain liquids away from solids in the foodstuffs), ribbed (e.g., also for drainage). In addition, the cooking surface (and the inner surface of the sidewall) may be coated (e.g., with a low-tack material (i.e., so-called “non-stick”)).

The sidewall may or may not be sloped. An angle of the sidewall is measured between the sidewall and a plane perpendicular to the cooking surface. The angle of the sidewall is equal to zero when it is not sloped (i.e., the sidewall is vertical) and is greater than zero when it is sloped. In further examples, the sidewall of the cookware may be rounded (e.g., bulging away from the cooking surface in the center of the sidewall). Each of the portions of the sidewall and the base wall has a thickness measured between the inner surface and the outer surface. The thickness may be constant or may vary.

A width of the cookware—which is also the diameter for circular cookware—is measured between opposing points on its outer edge. In contrast, a mouth of the cookware is measured between opposing points on its inner edge. A depth of the cookware is measured between the cooking surface (i.e., an inner surface of the base wall) and the edge of the cookware. A height of the cookware is measured between the outer surface of the base wall and the edge of the cookware. The height is largely determined by a height of the sidewalls, which are generally sized to prevent the foodstuffs from falling from the cookware while cooking (e.g., in the case of sautéing, which generally comprises the food being repeatedly tossed from the cooking surface into the air, from which it falls back onto the cooking surface). Some pots have a depth-to-width ratio of about 1:1 (i.e., the depth of the pot is approximately equal to the width of the cookware). Some pans and skillets have a depth-to-width ratio of 1:3 or less (i.e., the depth of the cookware is less than or equal to one third of a width of the cookware). Moreover, the height of a pan and/or skillet may be only a few centimeters (e.g., 5-10 cm) regardless of the width of the cookware (e.g., width of 20 cm or more). Some cookware also comprises a lid, which has a width that matches the width of the cookware. Because the widths of the lid and the cookware match, the lid (when placed on the cookware) rests on the edge of the cookware and, thereby, encloses the cavity of the cookware (e.g., to trap heat and/or moisture within the cavity).

Cookware users sometimes need to separate solid portions of foodstuffs from liquid portions of foodstuffs. For example, a user may wish to separate pasta (i.e., boiled in water) from the water in which it was boiled, to separate meat from any liquids (e.g., fat, water, and combinations thereof) rendered from the meat, or separate tea from the water in which it was boiled. However, the cookware and the foodstuffs are often hot from the cooking process, which makes it challenging to safely separate the solids and the liquids after cooking. External strainers may be used to separate the solids and the liquids; such strainers require transferring the foodstuffs from the cookware to the external strainer.

Some pots include perforations near a top of the pot for straining liquid. For example, a pot may include a lid with perforations; the liquid and the solids are separated from one another by tipping the pot (e.g., using both hands (one hand supporting the pot and the other hand holding the lid in contact with the opt) to ensure that the lid and the pot remained sealed together) until the liquid escapes the pot through the perforations in the lid. In other examples, a pot may include perforations in a wall near (e.g., immediately adjacent to) a top edge of the pot; the liquid and the solids are separated from one another by tipping the pot until the liquid escapes the pot through the perforations in the wall. In general, when the perforations are near the top of the pot (lid or top of wall), the liquid must to travel from the bottom of the pot (and pass through the solids) to reach the top of the pot and/or the lid. Such travel is inefficient for extracting the liquid at least because the liquid may, when passing through the solids, adhere to and/or absorb into the solids, which reduces the efficacy of the extraction process (e.g., by causing more of the liquid to stay in the pot, intermingled with the solids). In addition, when the perforations are near the top of the pot, the pot must be tilted at a high angle (and the lid held firmly in contact with the pot) to extract the liquid. In some cases, pots with opening near the top require tipping the pot at a tilt angle of about 30 degrees or more to extract the liquid (e.g., where the tilt angle is measured between a horizontal plane and a plane in which an outer bottom surface of the lies). Moreover, as the liquid drains, the user must continually increase the tilt angle to continue to remove liquid by forcing an ever decreasing level of liquid to overtop the edge of the skillet. For example, the user may eventually tilt the pot on its side (e.g., at a tilt angle of 90 degrees, where the bottom surface is vertical) and/or tilt the pot completely upside down (e.g., at a tilt angle of 180 degrees). Such tilting requires a user to use both hands to ensure that the lid and the pot remained sealed together to prevent the foodstuffs from dropping out of the pot. In addition, such tilting is potentially dangerous to the user at least because it requires holding a (potentially hot) pot at such an extreme angle that a user may be susceptible to dropping the pot and/or foodstuffs from the pot and injuring themselves, injuring others, and/or damaging the pot.

Some cooking vessels include perforations throughout the bottom and sidewalls for cooking via indirect heat (e.g., heat first transferred to a liquid in which the vessel is suspended). For example, steam baskets, deep frying baskets, and the like are perforated to allow a hot fluid (e.g., steam, oil) to enter the basket and cook the food and to allow the hot fluid leave the basket when it is removed from the hot fluid. The walls of the such baskets are suspended in the hot fluid during cooking and do not (and are not designed to) directly contact a flame, a gas burner, a heating coil, and the like. Any surface producing a fuel-burning fire (e.g., from gas burner) or surface-to-surface transfer of heat that is applied directly to the bottom of such baskets could enter the perforations and potentially burn the foodstuffs. These solutions are for cooking on indirect heat and are inadequate for use with cooking vessels that are in direct contact with a flame or heating producing surface during cooking.

Accordingly, there is a need for a solution to the challenge of safely separating solid portions of foodstuffs from liquid portions of foodstuffs using cooking vessels that are in direct contact with a flame and/or a heating producing surface during cooking. The embodiments described in the present disclosure address the challenges discussed above (as well as other challenges). The present disclosure describes various embodiments for safely separating solid portions of foodstuffs from liquid portions of foodstuffs during cooking.

According to one aspect of the present disclosure a cooking vessel (e.g., for cooking foodstuffs) comprises and a sidewall extending from the base wall. The base wall comprises a cooking surface configured to transmit heat to the foodstuffs. The sidewall comprises at least one opening to drain a liquid from the cooking surface. The at least one opening is adjacent to the cooking surface. The liquid drains from the cooking surface based on the at least one opening being adjacent.

The at least one opening is adjacent to the cooking surface. For example, the at least one opening may be located in a lower portion of the sidewall so that it is in close proximity to the cooking surface where liquids would naturally pool. In one embodiment, the lower portion of the sidewall is the lower 50% of the depth of the skillet. In other embodiment, the lower portion of the sidewall is the lower 20% of the depth of the skillet. In another embodiment, the lower portion of the sidewall is the lower 15% of the depth of the skillet. In still another embodiment, the lower portion of the sidewall is the lower 10% of the depth of the skillet. In general, the tilt angle needed to drain liquid from the cooking vessel decreases as the opening is moved closer to the cooking surface. The opening may be collinear with or may be offset from the cooking surface (and still contained within a lower threshold amount of the depth of the skillet). When the opening is collinear with the cooking surface the tilt angle is about 10 degrees or less. The tilt angle is about 15 degrees or more when the opening is offset from the cooking surface by about 0.5 cm (i.e., 0.5 cm between the bottom of the opening and the cooking surface).

It is noted that the cooking vessels disclosed in the present disclosure are for cooking directly on a heating producing surface. Thus, the entirety of the bottom wall is solid and lacks perforations (e.g., to prevent oils from falling into a fire underneath and catching fire and to prevent fire from entering the cooking cavity and burning the foodstuffs). During cooking, the heating surface comes in direct contact with fire for cooking the foodstuffs. The door, when in the closed position, prevents any and all liquid from escaping through the sidewall. This is in contrast to, e.g., steam baskets and deep frying basket, that are suspended in a steam or oil instead of a direct contact with fire or a heating coil. Moreover, any door placed at the bottom of the sidewall of a steam baskets and deep frying basket would be in effective for preventing liquid from escaping through the sidewall (e.g., due to the presence of other perforations in the upper portion of the sidewall).

Substantial flexibility is provided with respect to a shape, orientation, and location of the openings in the sidewall. The openings may any shape, e.g., a circle, an oval, a rectangle, a triangle, a polygon, a regular polygon (convex), and any other shape and/or combination thereof. For openings of elongated shapes (e.g., rectangles, ovals, and the like) a long dimension of the opening may be horizontally oriented (e.g., parallel to the cooking surface). In other examples, the long dimension of the opening may be vertically oriented (e.g., perpendicular to the cooking surface). The openings may be placed in various locations around the sidewall. For example, openings may be placed on a side (e.g., either side of the handle), opposite the handle, or even distributed about the entirety of the sidewall.

Example embodiments that may be used to implement the features and functionality of this disclosure will now be described with more particular reference to the attached FIGURES.

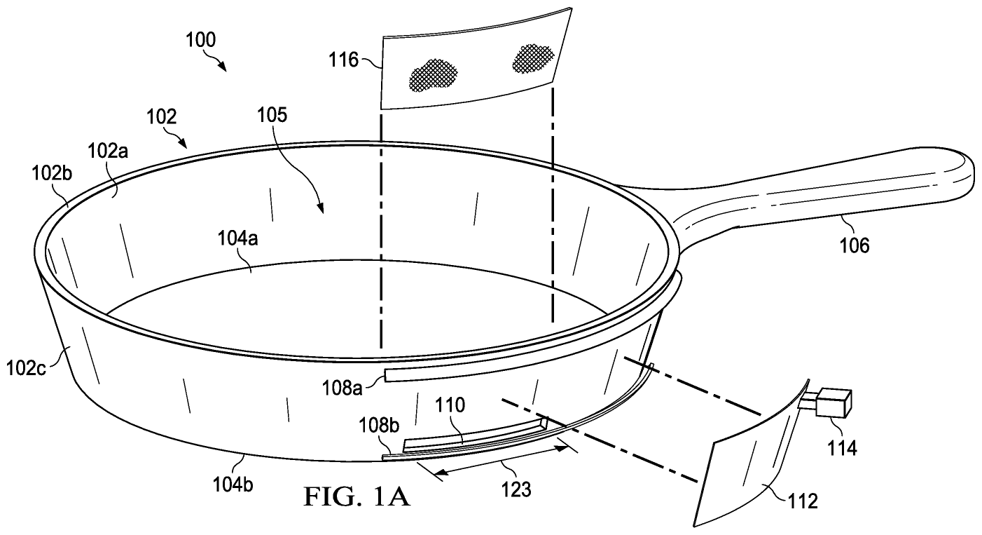

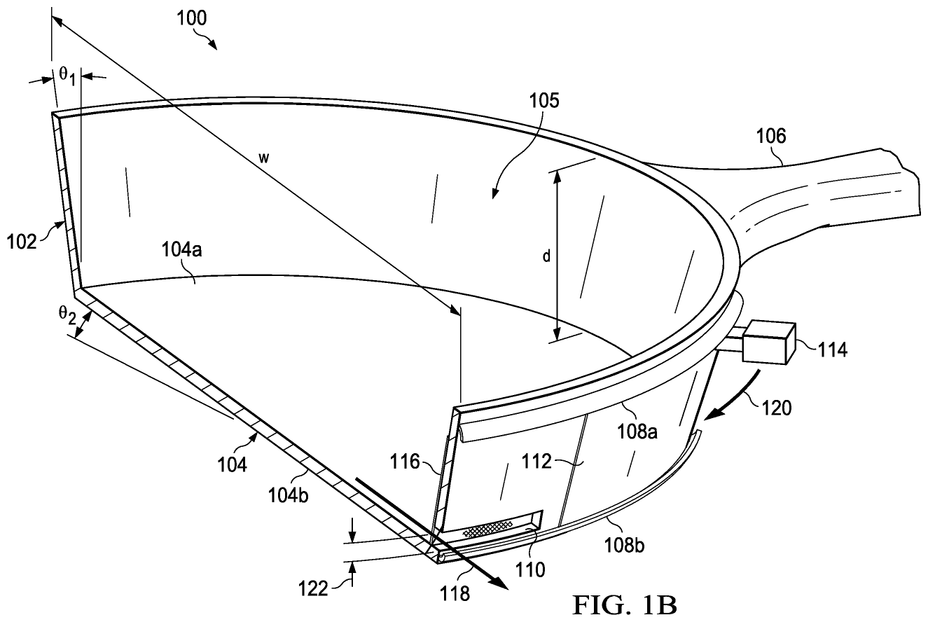

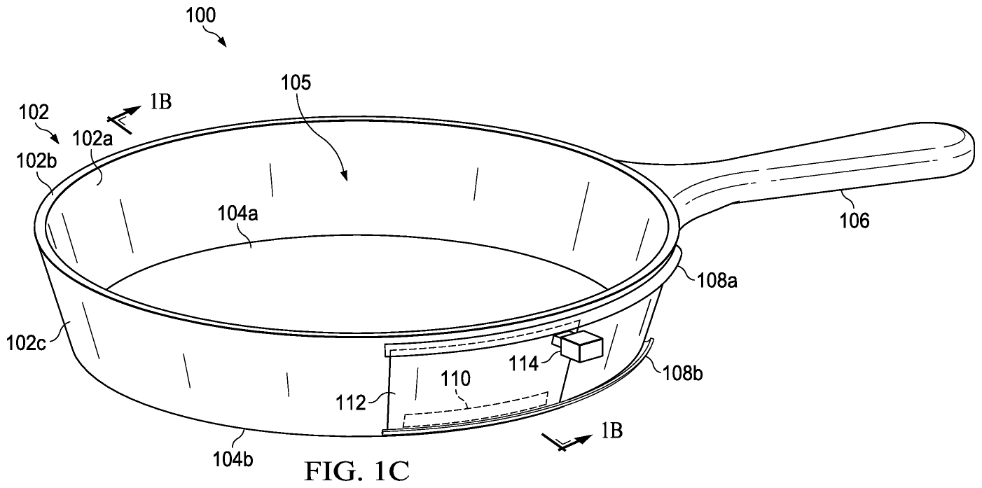

Turning to FIGS. 1A, 1B, and 1C, FIGS. 1A, 1B, and 1C illustrate various views of a cooking vessel (i.e., skillet 100) with an opening (i.e., opening 110) for drainage, according to an embodiment of the present disclosure. A single door corresponds to and selectively closes a single opening. FIG. 1A is a partially exploded diagram of the skillet 100. FIG. 1B is a cutaway view of the skillet 100 in operation when a door 112 is in an open position. FIG. 1C is a view of the skillet 100 when a door 112 is in a closed position. The following description of the skillet 100 makes simultaneous to the FIGS. 1A, 1B, and 1C unless otherwise noted.

The skillet 100 comprises a base wall 104, a sidewall 102, an opening 110 in the sidewall 102, a handle 106, tracks 108a and 108b, a mesh 116, a door 112, and a tab 114. The sidewall 102 and the base wall 104 are continuous with one another. The sidewall 102 extends upwardly from the base wall 104, at least in part, to define a cavity 105 in which to cook foodstuffs. An inner surface 102a of the sidewall 102 is tilted at an angle relative to the cooking surface 104a (i.e., the angle labeled θ₁ (theta 1) in FIG. 1B). The handle 106 is attached to the sidewall 102. The tracks 108a and 108b attach the door 112 to the sidewall 102. The tab 114 is attached to the door 112. A width, w, (or diameter) of the skillet 100 is measured between opposing points on its edge 102b. A depth, d, of the skillet 100 is measured between the cooking surface 104a and the edge 102b (along a line perpendicular to the cooking surface 104a). In this example, the depth of the skillet 100 is equal to a height of the sidewall 102. The depth is less than one third of the width. A tilt angle θ₂ (theta 2) is measured between a horizontal plane and a plane in which an outer bottom surface of the lies (e.g., as illustrated in FIG. 1B). The tilt angle is an angle at which the skillet 100 is tilted (e.g., while draining liquid from the skillet). The opening 110 is in the lower portion of the sidewall 102 to facilitate draining the skillet at a low tilt angle. The percentages labeled in FIG. 1B show fractions of the sidewall 102 in which the opening may be placed to maintain a tilt angle less than 45 degrees. In this example, the opening is fully contained within a lower 10% of the wall and is collinear with the cooking surface; liquid drains through the opening 110 while the skillet is at a tilt angle of 10 degrees or less (e.g., 5 degrees).

The skillet 100 is for cooking foodstuffs directly on a flame and/or a heating producing surface. A heating producing surface is inclusive of a burner on a gas range producing a fuel-burning fire (i.e., fires burning at temperatures at or above about 3500 degrees Fahrenheit), a heating coil on an electric range generating heat (i.e., producing heat at or above about 500 degrees Fahrenheit), a heating element of an electric cooktop (i.e., producing heat at or above about 300 degrees Fahrenheit), and the like. During cooking, the base wall 104 directly contacts the flame and/or the heating producing surface. The base wall 104 is solid and unperforated, which reduces the likelihood of liquids (e.g., liquid fats and/or oils) falling onto the flame and/or the heating producing surface underneath (e.g., and potentially creating an uncontrolled fire) and reduces the likelihood of the flame directly entering the cavity 105 (e.g., and potentially burning the foodstuffs). The base wall 104 comprises a heating surface 104b and a cooking surface 104a. The heating surface 104b is configured to receive heat directly from the flame and/or the heating producing surface. The heat radiates throughout the base wall 104 and to the sidewall 102. The heating surface 104b is on an opposite side of the base wall 104 relative to the cooking surface 104a. The cooking surface 104a transmits heat to the foodstuffs. For example, during cooking, the cooking surface 104a is in direct contact with the foodstuffs and directly transmits the heat to the foodstuffs. The sidewall 102 comprises an inner surface 102a, an edge 102b, and an outer surface 102c. The handle 106 is attached to the outer surface 102c. The handle 106 extends from the sidewall 102 and is operable to support the entire weight of the skillet and the foodstuffs. The handle remains cool (i.e., at a temperature about room temperature) even while the skillet is hot (e.g., based on the handle comprising an insulating material, and/or having a low thermal mass). A user can safely support the skillet 100 using the handle 106 (regardless of whether the skillet 100 is hot).

The opening 110 in the sidewall 102 enables liquid to drain from the cooking surface 104a. The opening 110 is located on a side of the handle 106, e.g., to enable tipping the skillet 100 using the handle 106 to drain liquid from the cooking surface 104a. The opening 110 extends through an entire thickness of the sidewall between the inner surface 102a and the outer surface 102c. The opening 110 is adjacent to the cooking surface 104a and is fully contained within a lower portion of the sidewall 102. An upper portion of the sidewall 102 is imperforate. The liquid drains directly from the cooking surface based at least in part on the opening 110 being adjacent to the cooking surface 104a. The opening 110 is a narrow rectangle in shape. A height 122 of the opening 110 is smaller than a width 123 of the opening 110. The opening 110 is horizontally oriented to be parallel to the cooking surface 104a. The width is horizontally oriented. The opening can prevent items larger than the height 122 from escaping the cooking vessel during draining. In a particular example, the height 122 is about 2-10 mm. In a further example, the width 123 is about 2-4 cm. In still another example, the height 122 is about 2-10 mm and the width 123 is about 2-4 cm.

The mesh 116 is permeable to liquids and is configured to cover the opening 110. Because solid portions of the foodstuffs smaller than the height 122 of the opening 110 could potentially pass through the opening 110, the mesh 116 prevents such solids from escaping while allowing liquid portions of the foodstuffs to pass through mesh 116 to reach the opening 110. In other words, the mesh 116 captures solids that are small enough to pass through the opening 110. Thus, the size of openings the mesh is smaller than the height 122 of the opening 110. In some embodiments, the mesh 116 is permanently attached to the inner surface 102a. In other embodiments, the mesh 116 is removably attached to the inner surface 102a. In such an embodiment, a user of the skillet 100 can decide whether or not to use the mesh based on the application (e.g., based on the size of solids portions of the foodstuffs).

The door 112 is operable to selectively block the opening 110. The door 112 is attached to the outer surface 102c by an attachment mechanism. The attachment mechanism comprises tracks 108a and 108b into which the door 112 fits and slides. The door 112 is movable between an open position and a closed position. FIG. 1B illustrates the door 112 in the open position. FIG. 1C illustrates the door 112 in the closed position. The door 112 slides within the tracks 108a and 108b between the open position and the closed position. In the closed position, the door 112 covers the opening 110 (as illustrated in FIG. 1C) to prevent the liquid from escaping through the opening 110. The door 112 is solid (i.e., unbroken and lacks perforations) and is at least as wide as the opening 110 to fully block the opening 110 in the closed position. In the open position, the door 112 exposes the opening 110 (as illustrated in FIG. 1B) to allow the liquid to escaping through the opening 110. A tab 114 is attached to the door 112. The tab is a lever to facilitate moving the door 112 between the open position and the closed position. For example, the door 112 is movable between the open position and the closed position in a horizontal axis; a force applied in a direction 120 in the horizontal axis (as illustrated in FIG. 1B) moves the door 112 from the open position and the closed position. The door 112 can remain closed while cooking the foodstuffs on the flame and/or the heating producing surface. Once removed from the flame and/or the heating producing surface, the door 112 is opened to drain liquids from the foodstuffs.

Turning to FIG. 1B, FIG. 1B illustrates liquid draining from the cooking surface 104a through the mesh 116 and the opening 110. The opening 110 is adjacent to the cooking surface 104a. Liquid (such as fat, oils, water, combinations thereof) may render from foodstuffs being cooked on the cooking surface 104a of the skillet 100. The opening 110 being in close proximity to the cooking surface 104a advantageously facilitates drainage the liquid while the skillet 100 is at a relatively low tilt angle. For example, the liquid drains at a tilt angle of about 45 degrees or less, about 30 degrees or less, about 20 degrees or less, or about 10 degrees or less. The skillet 100, as illustrated in FIG. 1B, is tipped at a tilt angle of about 10 degrees; the liquid drains from the cooking surface 104 through the opening 110 in a direction as generally indicated by 118.

The opening 110 being adjacent to the cooking surface 104a comprises the opening 110 being located in a lower portion of the sidewall adjacent to the cooking surface 104a. For example, the opening 110 is fully contained within a lower 20% of the height of the sidewall 102. No portion of the opening 110 extends beyond the lower 20%. In addition, a bottom surface of opening 110 (e.g., a lowest point within the opening) is collinear with the cooking surface 104a. The upper portion of the sidewall 102 is solid with no openings. The upper portion may comprise an upper 80% of the height of the sidewall 102, an upper 50% of the height of the sidewall 102. In a particular embodiment, the opening 110 is fully contained within about 1 centimeter of the cooking surface. Because the opening 110 is adjacent to the cooking surface 104a, the direction 118 of liquid drainage does not travel up and over the sidewall 102 to drain and, instead, travels only through and/or under the sidewall 102. The liquid drains directly from the cooking surface 104a (and not along the sidewalls) through the opening 110 (i.e., as illustrated by the direction 118).

Advantageously, a user may drain liquid from the skillet 100 using only one hand. The low tilt angle (i.e., in this case 10 degrees) needed to drain the liquid avoids the need to use the lid (and a second hand hold the lid) to prevent the foodstuffs from falling out. In addition, the liquid is not forced to pass through the depth of the foodstuffs to drain from the skillet (e.g., the liquid does not to travel from the bottom to the top of the skillet 100 while draining). Indeed, the direction 118 of liquid drainage is more efficient (i.e., results in more of the liquid to be removed in the skillet) than sending the liquid back through the solids to the top of the skillet. Moreover, as the liquid drains, the user can maintain the same the tilt angle to continue to remove liquid. Because the liquid drains from the bottom of the sidewall and continuing drainage does not require continually increasing the tilt angle to force the liquid to overtop the edge of the skillet. Indeed, substantially all liquid can be drained from the skillet 100 by while holding constant a tilt angle of about 25 degrees or less. Furthermore, the low tilt angle avoids the need to completely tip the skillet upside down (e.g., avoids a tilt angle of 180 degrees), which reduces the likelihood of a user dropping the skillet and/or foodstuffs from the skillet and injuring themselves, injuring others, and/or damaging the skillet.

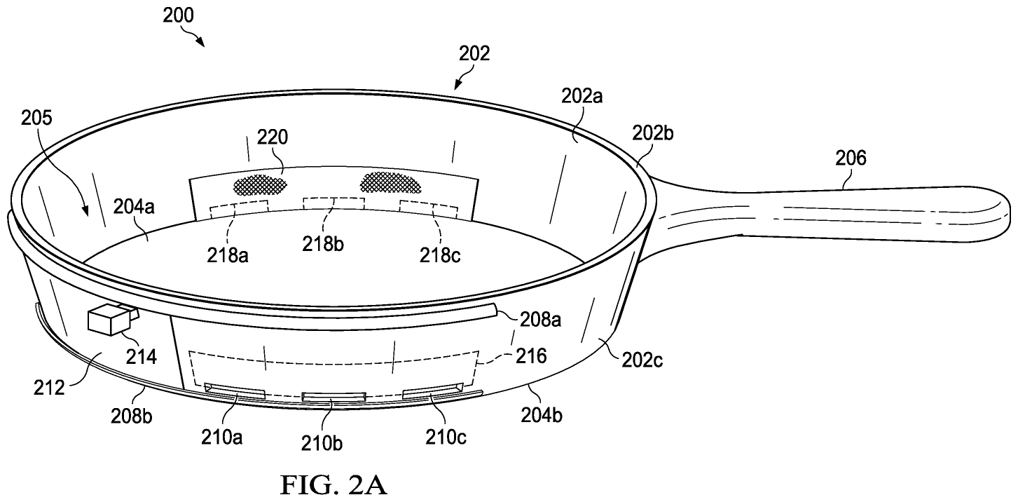

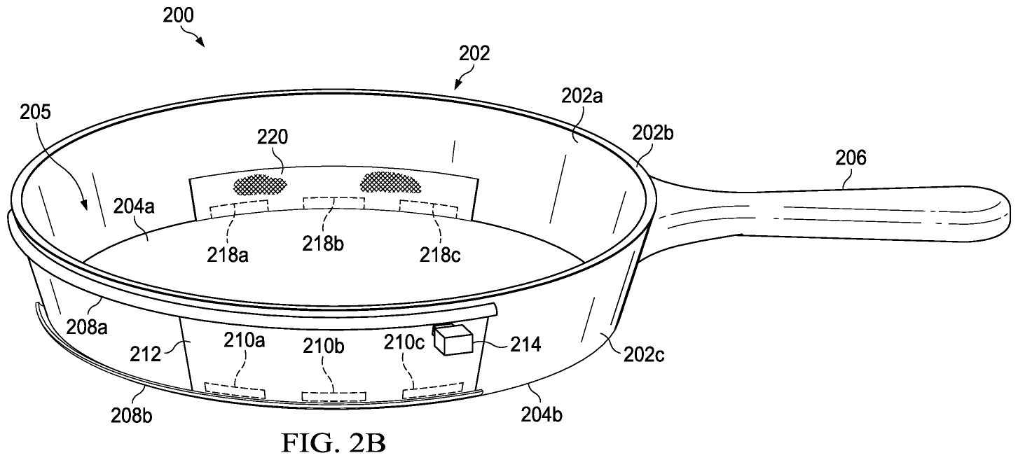

While the skillet 100 (as illustrated in FIGS. 1A, 1B, and 1C) includes a single opening 112, embodiments of the present disclosure are not limited to a single opening. Other embodiments include multiple instances of the opening 110 and the door 112 (i.e., multiple openings and multiple doors). In such embodiments, each of the multiple openings has a corresponding door. Each door can operate independently to close its corresponding opening. In still other embodiments, a single door can close multiple openings, as illustrated in FIGS. 2A and 2B, described below.

Turning to FIGS. 2A and 2B, FIGS. 2A and 2B illustrate various views of a cooking vessel (i.e., skillet 200) with multiple openings on multiple sides for drainage. Each door on the skillet 200 is configured to selectively close one or more of three openings. FIG. 2A is a view of the skillet 200 when a door 212 is in an open position. FIG. 2B is a view of the skillet 200 when the door 212 is in a closed position. The following description of the skillet 200 makes simultaneous to the FIGS. 2A and 2B unless otherwise noted.

The skillet 200 comprises a base wall 204, a sidewall 202, multiple openings (e.g., openings 210a, 210b, and 210c, and openings 218a, 218b, and 218c) in the sidewall 202, a handle 206, an attachment mechanism comprising tracks (i.e., a set of tracks (a first set): track 208a and track 208b, and another set of tracks (a second set), not visible), multiple of meshes (i.e., mesh 216 and mesh 220), multiple doors (i.e., door 212 (a first door) and another door (a second door, not visible)), and multiple tabs (i.e., tab 214 (a first tab) and another tab (a second tab, not visible)). The skillet 200 is for cooking foodstuffs directly on a flame and/or a heating producing surface. The base wall 204 comprises a heating surface 204b and a cooking surface 204a. The sidewall 202 comprises an inner surface 202a, an edge 202b, and an outer surface 202c. The handle 206 is attached to the outer surface 202c. The sidewall 202 extends upwardly from the base wall 204, at least in part, to define a cavity 205 in which to cook foodstuffs.

The skillet 200 (of FIGS. 2A and 2B) is similar to the skillet 100 (of FIGS. 1A, 1B, and 1C). Thus, the components of the skillet 200 operate and relate to one another as is described with respect to the skillet 100 of FIGS. 1A, 1B, and 1C). In addition, a width, sidewall height (depth), and tilt angle, are measured on the skillet 200 as is described with respect to the skillet 100 of FIGS. 1A, 1B, and 1C. The description is not repeated here only for brevity. Some differences include that the skillet 200 has a vertical sidewall (while the skillet 100 has a sloped sidewall) and the skillet 200 has multiple openings that are selectively covered by a single door (while the skillet 100 has one opening that is selectively covered by one door). An inner surface 202a of the sidewall 202 is perpendicular to the cooking surface 204a.

The openings 210a, 210b, and 210c (referred to collectively as openings 210) and the openings 218a, 218b, and 218c (referred to collectively as openings 218) in the sidewall 202 enables liquid to drain from the cooking surface 204a. The openings 210 are located on a first side of the handle 206, e.g., to enable draining liquid from the cooking surface 204a by tilting the skillet 200 toward the first side using the handle 206. The openings 218 are located on a second side of the handle 206, e.g., to enable draining liquid from the cooking surface 204a by tilting the skillet 200 toward the second side using the handle 206. Each of the openings 210 extend through an entire thickness of the sidewall 202 between the inner surface 202a and the outer surface 202c. Each of the openings 210 and the openings 218 is adjacent to the cooking surface 204a and is fully contained within a lower portion of the sidewall 202. An upper portion of the sidewall 202 is imperforate. The liquid drains directly from the cooking surface based at least in part on the openings 210 and the openings 218 being adjacent to the cooking surface 204a. Each of the openings 210 and the openings 218 is a narrow rectangle in shape. A height of each of the openings is much smaller than a width of the openings (e.g., similar to the opening 110 in the skillet 100).

Each of the meshes 216 and 220 is permeable to liquids. The mesh 216 covers the openings 210. The mesh 220 covers the openings 218. Due to the permeability of the meshes 216 and 220, liquid can flow through the meshes 216 and 220 and out of the openings 210 and 218 while the meshes 216 and 220 cover the openings 210 and 218. The size of openings in each mesh is smaller than the height of the openings. Because solid portions of the foodstuffs smaller than the height of the openings could potentially pass through the openings, the meshes prevent such solids from escaping while allowing liquid portions of the foodstuffs to pass through meshes to reach the openings. The meshes 216 and 220 capture solids that are small enough to pass through the openings. In some embodiments, the meshes 216 and 220 are permanently attached to the inner surface 202a. In other embodiments, the meshes 216 and 220 are removably attached to the inner surface 202a.

Each door is configured to selectively block one or more of the corresponding openings. The door 212 (i.e., the first door) is configured to selectively block one or more of the openings 210a, 210b, and 210c. The tracks 208a and 208b (i.e., the first set of tracks) couple the door 212 to the sidewall 202. The tab 214 is affixed to the door 212. Another door (i.e., the second door) is configured to selectively block one or more of the openings 218a, 218b, and 218c. Another set of tracks (i.e., the second set of tracks) couple the second door to the sidewall 202 (on an opposite side of the pan relative to the first door). Another tab (i.e., the second tab) is affixed to the second door.

The door 212 is moveable between the open position and the closed position. FIG. 2A illustrates the door 212 in the open position. FIG. 2B illustrates the door 212 in the closed position. The door 212 slides within the tracks 208a and 208b between the open position and the closed position. In the closed position, the door 212 covers all of the openings 210 (as illustrated in FIG. 2B) to prevent the liquid from escaping through the openings 210. The door 212 is solid (i.e., unbroken and lacks perforations) and spans across the openings 210 to fully block all of the openings 210 in the closed position. In the open position, the door 212 exposes all of the openings 210 (as illustrated in FIG. 2A) to allow the liquid to escape through the openings 210. The tab 214 facilitates moving the door 112 between the open position and the closed position. For example, a force applied to the tab 214 in a horizontal axis moves the door 212 between the open position and the closed position. The doors progressively closes/reveals the openings. While moving the door 212 from the open position to the closed position, the door 212 first blocks the opening 210a (i.e., only opening 210a is blocked), next blocks the opening 210b (i.e., both opening 210a and opening 210b are blocked), and finally blocks the opening 210c (i.e., all openings 210 are blocked). While moving the door 212 from the closed position to the open position, the door 212 first reveals the opening 210c (i.e., only opening 210c is exposed), next reveals the opening 210b (i.e., both opening 210c and opening 210b are exposed), and finally reveals the opening 210a (i.e., all openings 210 are exposed). Moreover, the door 212 may maintain a position between the open position and the closed position to scale the amount of drainage provided based on the number (or fraction) or one or more of the openings is exposed. For example, a user may choose to open only one of the openings 210, open only two of the openings 210, or open all the openings 210 based on the rate at which they want to drain liquid from the skillet. The second door (which slides within the second set of tracks to selectively close the openings 218) operates as is described for the door 212; the description is not repeated here only for brevity.

The doors on a skillet are independently operable. In the example of skillet 200, the first door can remain open (and/or partially open) while the second door is closed and vice versa. A user may choose which of the doors to open based on a door being aligned in a direction of tilt that is most comfortable given their handedness (e.g., left-handed or right-handed). Moreover, both doors can be open to quickly drain liquid from both sides of the skillet 200. Both doors can be closed to prevent liquid from draining from the skillet 200 (e.g., while cooking).

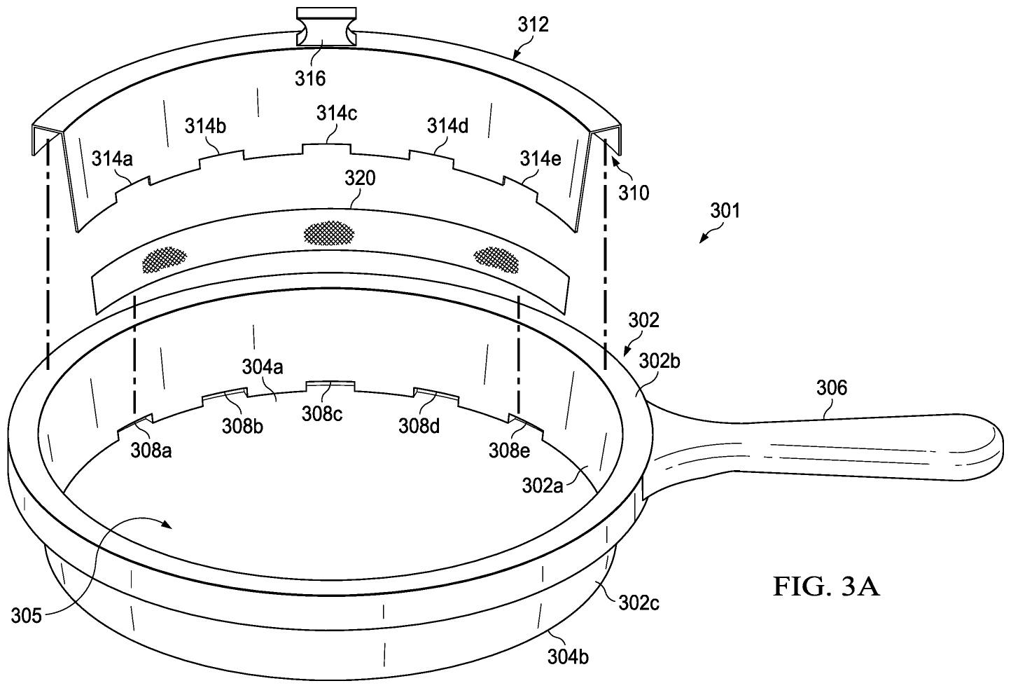

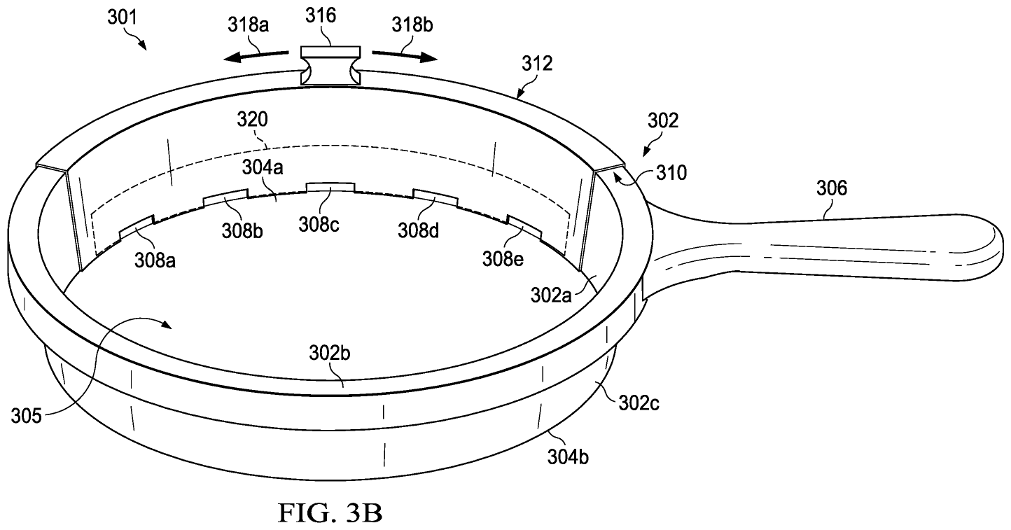

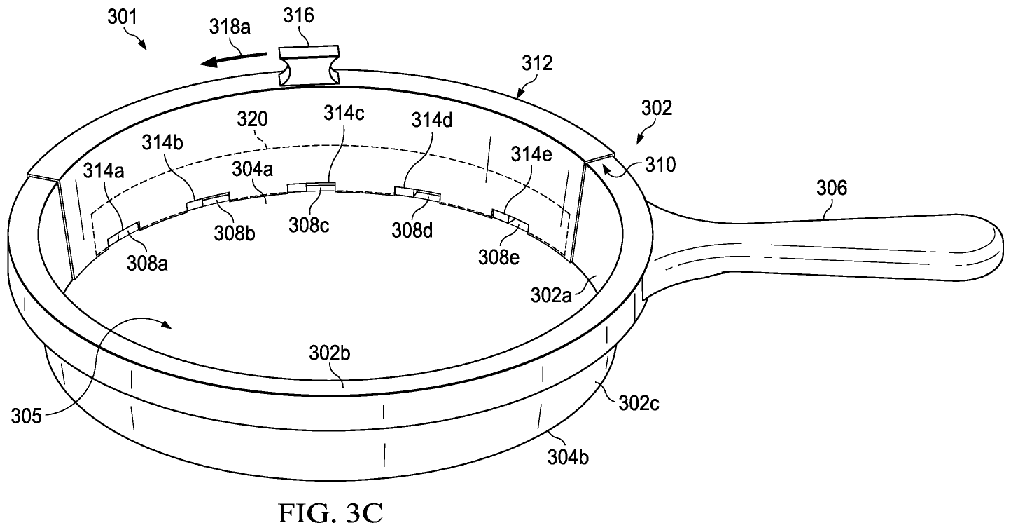

While each of the skillet 100 (as illustrated in FIGS. 1A, 1B, and 1C) and the skillet 200 (as illustrated in FIGS. 2A and 2B) includes or more doors coupled to an outside of a sidewall, the embodiments of the present disclosure are not limited to a placement opening. Other embodiments include a door attached at other locations on the cooking vessel. For example, a door located at an inner surface of the sidewall can close multiple openings, as illustrated in FIGS. 3A, 3B, and 3C, described below.

It is noted that a cooking vessel is sometimes referred to as a skillet when theta 1 is greater than zero (i.e., the sidewall is non-vertical relative to the cooking surface, as is shown in FIGS. 1A, 1B, and 1C) and is sometimes referred to as a pan when theta 1 is equal to zero (i.e., the sidewall is vertical and substantially perpendicular to the cooking surface, as is shown in FIGS. 3A, 3B, and 3C).

FIGS. 3A, 3B, and 3C illustrate various views of a cooking vessel (i.e., pan 301) with multiple openings for drainage, according to an embodiment of the present disclosure. A door 312 corresponds to and selectively closes one or more of openings 308a, 308b, 308c, 308d, and 308e. FIG. 3A is a partially exploded diagram of the pan 301. FIG. 3B is a view of the pan 301 when a door 312 is in an open position. FIG. 3C is a view of the pan 301 when a door 312 between the open position and a closed position. The following description of the pan 301 makes simultaneous to the FIGS. 3A, 3B, and 3C unless otherwise noted.

The pan 301 comprises a base wall 304, a sidewall 302, multiple openings (i.e., the openings 308a, 308b, 308c, 308d, and 308e) in the sidewall 302, a handle 306, a mesh 320, a door 312, and a tab 316. The pan 301 is for cooking foodstuffs directly on a flame and/or a heating producing surface. The base wall 304 comprises a heating surface 304b and a cooking surface 304a. The sidewall 302 comprises an inner surface 302a, an edge 302b, and an outer surface 302c. The handle 306 is attached to the outer surface 302c. The sidewall 302 extends upwardly from the base wall 304, at least in part, to define a cavity 305 in which to cook foodstuffs. The openings 308a, 308b, 308c, 308d, and 308e (referred to collectively as openings 308) in the sidewall 302 enable liquid to drain from the cooking surface 304a. Each of the openings 308 is adjacent to the cooking surface 304a and is fully contained within a lower portion of the sidewall 302. An upper portion of the sidewall 302 is imperforate. The mesh 320 is permeable to liquids. The mesh 320 covers the openings 308 and, due to its permeability, allows liquid to flow through.

The pan 301 (of FIGS. 3A, 3B, and 3C) is similar to the skillet 200 (of FIGS. 2A and 2B). Thus, the components of the pan 301 operate (e.g., to drain liquid) and relate to one another as is described with respect to the skillet 200 (of FIGS. 2A and 2B); the description is not repeated here only for brevity. Some differences include that the pan 301 has a door including recessions corresponding to the openings (while the skillet 200 has an unbroken rectangular shaped door); the door is located on an inside of the pan 301 (while the door is located on an outside of the skillet 200); the sidewalls are vertical on the pan 301 (while the sidewalls are non-vertical on the skillet 200); and the mesh is located on an outside of the pan 301 (while the mesh is located on an inside of the skillet 200).

The door 312 is configured to selectively block the openings 308. A lip 310 is an attachment mechanism that wraps the edge 203b of the sidewall 302 to couples the door 312 is to the sidewall 202. The tab 316 is affixed to a top of the lip 310 of the door 312. The door 312 comprises recessions 314a, 314b, 314c, 314d, and 314e (referred to collectively as recessions 314) in the bottom edge of the wall. Tabbed portions of the wall 312 lie between (and adjacent to) the openings 314. Each of the recessions 314a, 314b, 314c, 314d, and 314e corresponds to a respectively one of the openings 308a, 308b, 308c, 308d, and 308e. A size and shape of the recessions 314 matches a size and shape of the openings 308. In addition, a size and shape of the tabbed portions matches the size and shape of the openings 308. The door 212 is moveable between the open position and the closed position.

FIG. 3B illustrates the door 312 in the open position. FIG. 2B illustrates the door 312 in midway between the open position and the closed position. The lip 310 guides the door 312 on the edge 302b while the door slides between the open position and the closed position. Because the tabbed portions match the openings (i.e., in size and shape), in the closed position, the tabbed portions of the door 312 cover all of the openings 308 to prevent liquid from escaping through the openings 308. The door 312 spans across the openings 308 to fully block all of the openings 308 in the closed position. Because the recessions match the openings (i.e., size and shape), the recessions in the door 312 exposes all of the openings 308 (as illustrated in FIG. 3B) to allow the liquid to escape through the openings 210 when the door 312 is in the open position. The tab 316 facilitates moving the door 312 between the open position and the closed position. The door 312 is movable between the open position and the closed position in a horizontal axis. A force applied in a direction 318a or in a direction 318b (each of which is in the horizontal axis, as illustrated in FIG. 3B) moves the door 312 from the open position FIG. 3B to the closed position.

The door 312 simultaneously closes/reveals each of the openings 308. While moving the door 312 from the open position to the closed position, the door 312 simultaneously blocks an increasing portion of each of the openings 308. While moving the door 312 from the closed position to the open position, the door 312 simultaneously reveals an increasing portion of each of the openings 308. Moreover, the door 312 may maintain a position between the open position and the closed position to scale the amount of drainage provided based on the fraction of each the openings 308 that is exposed (as illustrated in FIG. 3C). For example, a user may choose to open the openings 308 by only 25% each, by only 50% each, by only 75% each, or completely open each (i.e., by 100%) based on the rate at which they want to drain liquid from the skillet.

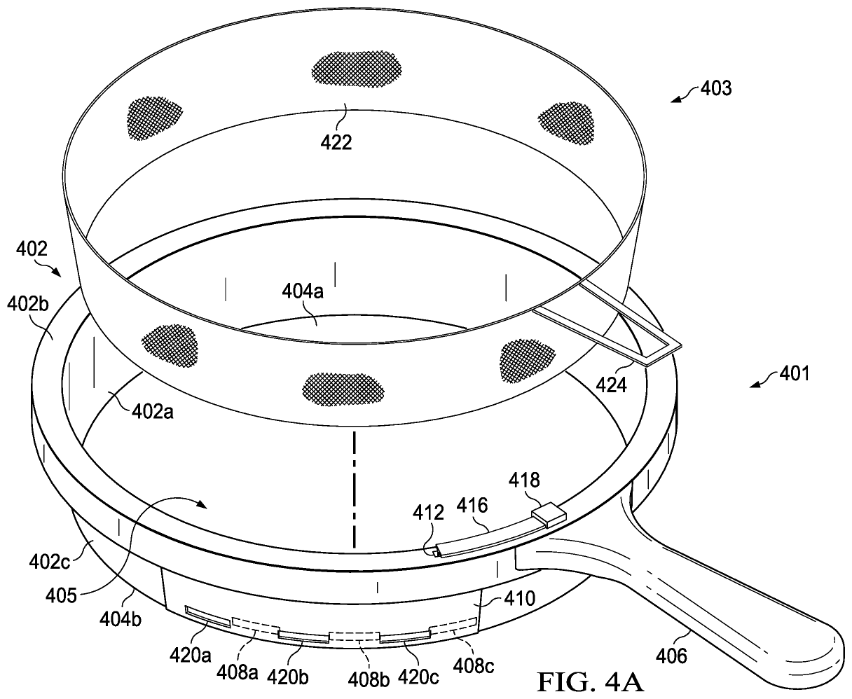

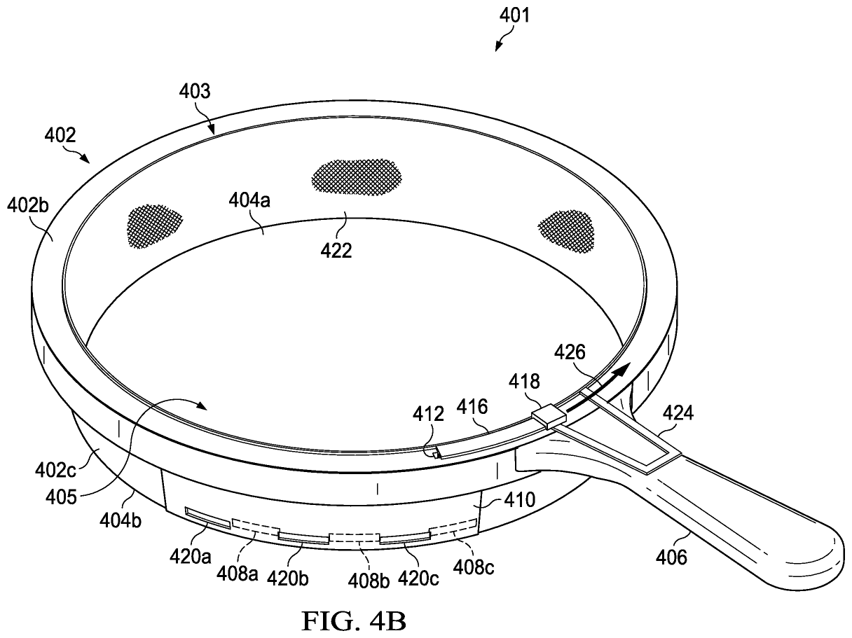

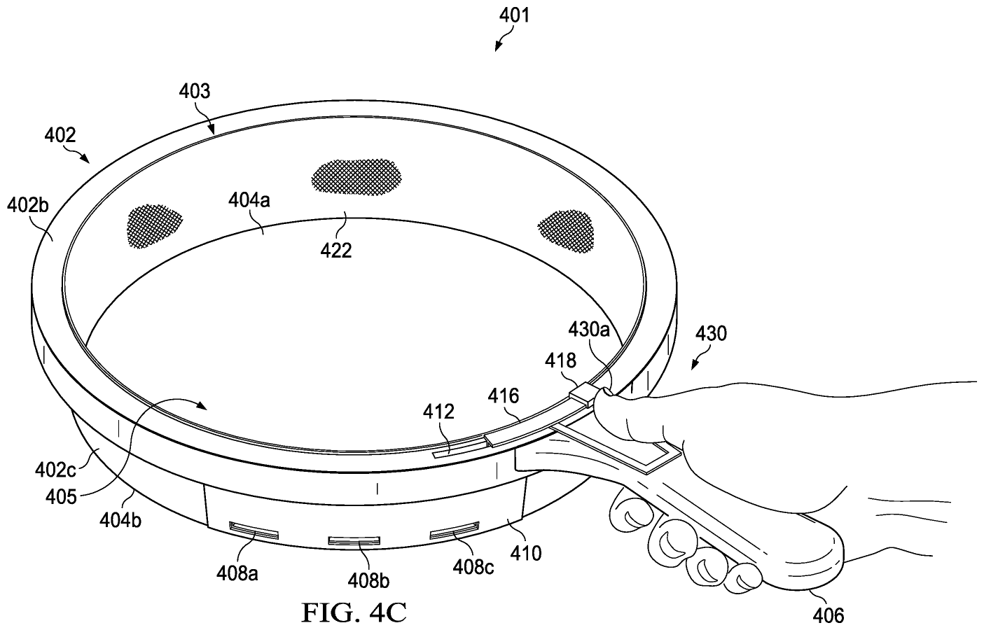

Turning to FIGS. 4A, 4B, and 4C, FIGS. 4A, 4B, and 4C illustrate various views of a cooking vessel (i.e., pan 401) with multiple openings (i.e., openings 408a, 408b, and 408c) adjacent to a handle for drainage, according to an embodiment of the present disclosure. A door 410 corresponds to and selectively closes one or more of the openings 408a, 408b, and 408c. FIG. 4A is a partially exploded diagram in which the pan 401 and a mesh insert 403 are separated from one another. FIG. 4B is a view of the mesh insert 403 fitted into the pan 401. The door 410 is in the closed position in FIGS. 4A and 4B. FIG. 4C is a view of the pan 401 when the door 410 is in the open position. The following description of the pan 401 and the mesh insert 403 makes simultaneous to the FIGS. 4A, 4B, and 4C unless otherwise noted.

The pan 401 comprises a base wall 404, a sidewall 402, multiple openings (i.e., the openings 408a, 408b, and 408c) in the sidewall 402, a handle 406, a door 410, and the mesh insert 403. The pan 401 is for cooking foodstuffs directly on a flame and/or a heating producing surface. The base wall 404 comprises a heating surface 404b and a cooking surface 404a. The sidewall 402 comprises an inner surface 402a, an edge 402b, and an outer surface 402c. The handle 406 is attached to the outer surface 402c. The sidewall 402 extends upwardly from the base wall 404, at least in part, to define a cavity 405 in which to cook foodstuffs. The openings 408a, 408b, and 408c (referred to collectively as openings 408) in the sidewall 402 enable liquid to drain from the cooking surface 404a. Each of the openings 408 is adjacent to the cooking surface 404a and is fully contained within a lower portion of the sidewall 402. An upper portion of the sidewall 402 is imperforate. The mesh insert 403 comprises a mesh 422 and a handle 424, which is attached to the mesh 422. The mesh insert 403 is removably insertable into the cavity 405. When fully inserted into the cavity 405, the mesh 422 aligns with and contacts the inner surface 402a of the sidewall 403. The mesh 422 is permeable to liquids. When inserted into the cavity 405, the mesh 422 covers the openings 408 and, due to its permeability, allows liquid to flow through. The mesh 422 filters solids form the liquid and does not allow solids of a certain size to pass through.

The pan 401 (of FIGS. 4A, 4B, and 4C) is similar to the skillet 200 (of FIGS. 2A and 2B). Thus, the components of the pan 401 operate (e.g., to drain liquid) and relate to one another in a similar manner as is described with respect to the skillet 200 (of FIGS. 2A and 2B); the description is not repeated here only for brevity. Some differences include that the pan 401 has including openings in a door that correspond to the openings in the sidewall (while the skillet 200 has an unbroken rectangular shaped door); the mesh 422 is located on an outside of the pan 401 (while the mesh is located on an inside of the skillet 200); the sidewall is vertical on the pan 401 (while the sidewall is non-vertical on the skillet 200); and the door 410 is movable based on a tab 418 located on a bracket 416 that extends through an opening 412 in the edge 402b of the sidewall 402 (while the tab protrudes away from the outer surface of the sidewall of the skillet 200).

The door 410 is configured to selectively block the openings 408. The bracket 416 extends upward from the door through the opening 412 in the edge 402b of the sidewall 402. The tab 416 is affixed to a top of the bracket 416. The door 412 comprises openings 314a, 420a, 420b, and 420c (referred to collectively as openings 420) near a bottom edge of the door 412. Solid portions of the wall 410 lie between (and adjacent to) the openings 410 in the wall. Each of the openings 420 corresponds to a respective one of the openings 408. A size and shape of each of the openings matches a size and shape of each of the openings 408. In addition, a size and shape of each of the solid portions of the wall 410 matches a size and shape of each of the openings 408. The door 412 is moveable between an open position and a closed position.

FIGS. 4A and 4B illustrate the door 410 in the closed position. Because the solid portions of the door 410 match the openings (i.e., in size and shape), in the closed position, the solid portions of the door 410 cover all of the openings 408 (as illustrated in FIGS. 4A and 4B) to prevent liquid from escaping through the openings 408. The door 410 spans across the openings 408 to fully block all of the openings 408 in the closed position.

FIG. 4C illustrates the door 410 in the open position. Because the openings 420 match the openings 408 (i.e., in size and shape), the openings 420 in the door 410 expose all of the openings 408 (as illustrated in FIG. 4C) to allow the liquid to escape through the openings 408 when the door 410 is in the open position. When the mesh insert 403 is in place, the liquid is filtered through the mesh 422 before it drains through the openings 408.

The door 410 is movable between the open position and the closed position. The tab 418 facilitates moving the door 410 between the open position and the closed position. The opening 416 guides the door 410 while is slides between the open position and the closed position. A force applied in horizontal direction (e.g., a direction 426, as illustrated in FIG. 4B) moves the door 410 from the closed position (FIG. 4B) to the open position (FIG. 4C). When the door 410 is closed, a force applied in a direction opposite to the direction 426 moves the door 410 from the open position (FIG. 4C) to the closed position (Figure BC). For example, the FIG. 4C illustrates a user's hand 430 holding the handle 406. While holding the handle, the user may place their thumb 430a on the tab 418 to move the door 410 between the open position and the closed position. Advantageously, a user may drain liquid from the pan 401 using only one hand (i.e., the hand 430). The low tilt angle needed to drain the liquid from the openings 408 avoids the need to use the lid (and a second hand hold the lid) to prevent the foodstuffs from falling out. Moreover, the tab 418 being in close proximity to the handle 406 enables opening and/or closing the door using only one hand. The door 410 simultaneously closes or reveals each of the openings 408 during closing or opening the door 410, respectively. While moving the door 410 from the open position to the closed position, the door 410 simultaneously blocks an increasing portion of each of the openings 408. While moving the door 410 from the closed position to the open position, the door 410 simultaneously reveals an increasing portion of each of the openings 408. Moreover, the door 410 may maintain a position between the open position and the closed position, e.g., to scale the amount of drainage provided based on the fraction of each the openings 408 that is exposed. For example, a user may choose to open the openings 408 by only 25% each, by only 50% each, by only 75% each, or completely open each (i.e., by 100%) based on the rate at which they choose to drain liquid from the skillet.

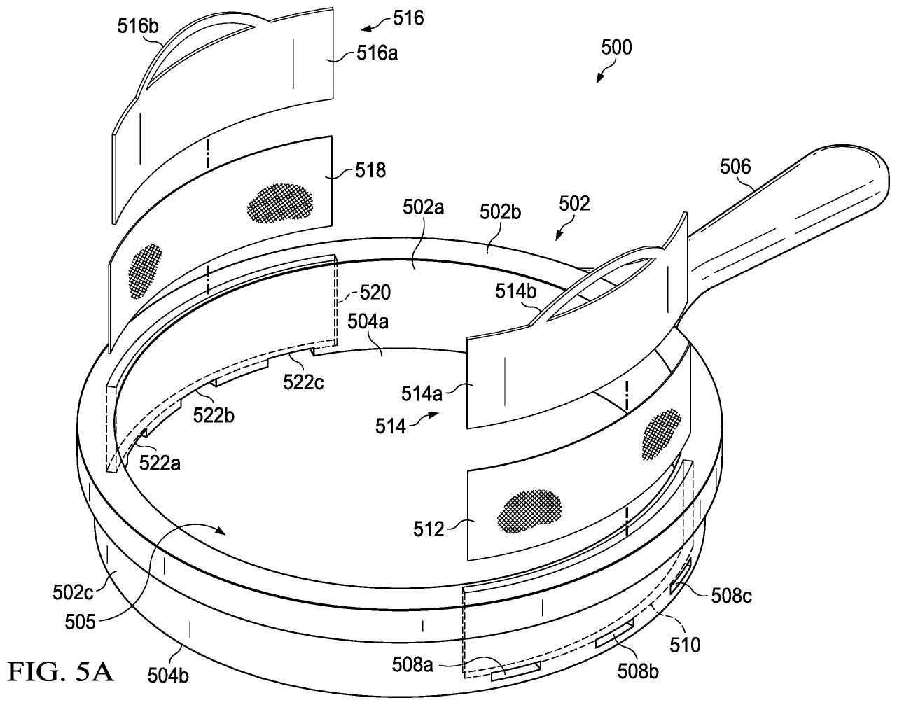

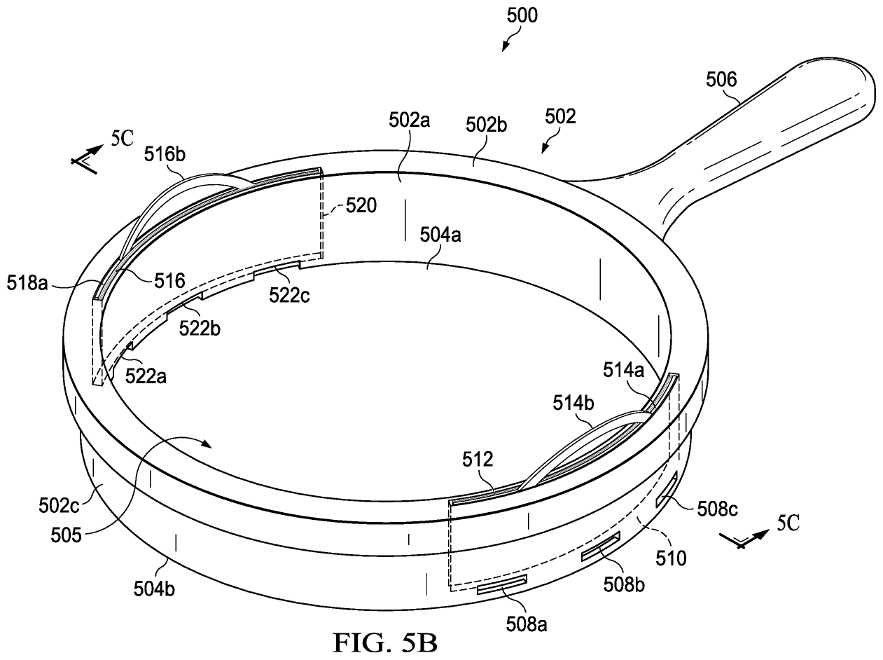

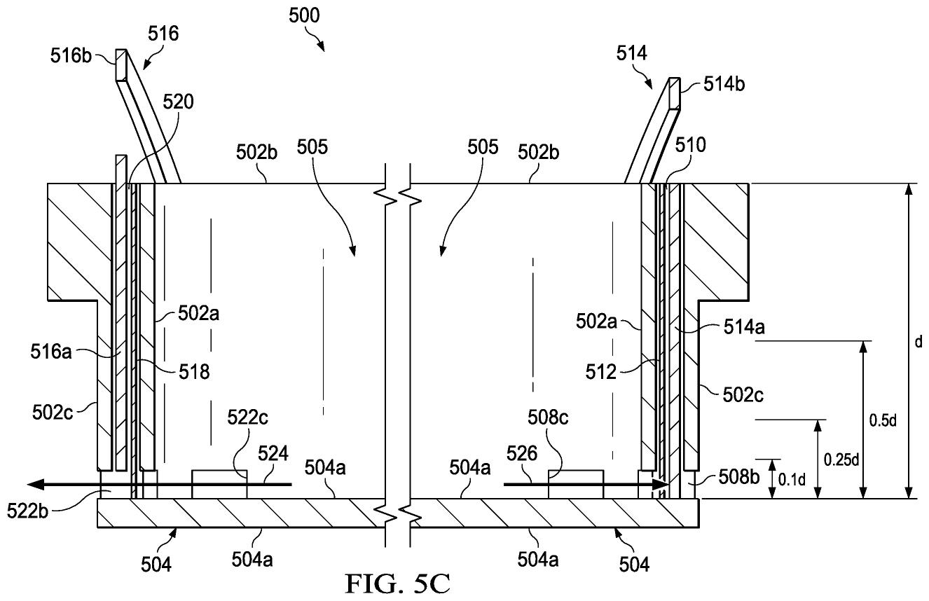

FIGS. 5A, 5B, and 5C illustrate various views of a cooking vessel (i.e., pan 500) with multiple openings in a hollow portion of a wall for drainage, according to an embodiment of the present disclosure. A single door corresponds to and selectively closes the multiple opening. FIG. 5A is a partially exploded diagram of the pan 500. FIG. 5B is a view of the pan 500 in operation when each of doors 516 and 514 is in a closed position. FIG. 5C is a section through the pan 500 when the door 516 is in an open position and the door 514 is in a closed position. The following description of the pan 500 makes simultaneous to the FIGS. 5A, 5B, and 5C unless otherwise noted.

The pan 500 comprises a base wall 504, a sidewall 502, multiple openings (i.e., openings 508a, 508b, and 508c, and openings 522a, 522b, and 522c) in the sidewall 502, a handle 506, the doors 516 and 514, and the meshes 518 and 512. The pan 500 is for cooking foodstuffs directly on a flame and/or a heating producing surface. The base wall 504 comprises a heating surface 504b and a cooking surface 504a. The sidewall 502 comprises an inner surface 502a, an edge 502b, and an outer surface 502c. The handle 506 is attached to the outer surface 402c. The sidewall 502 extends upwardly from the base wall 504, at least in part, to define a cavity 505 in which to cook foodstuffs. The sidewall 502 also includes a cavity 510 and a cavity 520, each of which is an attachment mechanism configured to support the doors and the meshes. The openings 508a, 508b, and 508c (referred to collectively as openings 508) and the openings 522a, 522b, and 522c (referred to collectively as openings 522) in the sidewall 502 enable liquid to drain from the cooking surface 504a. Each of the openings 508 and the openings 522 is adjacent to the cooking surface 504a and is fully contained within a lower portion of the sidewall 502. An upper portion of the sidewall 502 is imperforate. The cavities 510 and 520 intersect the openings 508 and 522 respectively. Each of the mesh 518 and the door 516 is (independently) removably insertable into the cavity 520. The mesh 518, when inserted into the cavity 520, covers the openings 522 and, due to its permeability, allows liquid to flow through. The door 516, when inserted into the cavity 520, blocks liquid to flow through the openings 522. Each of the mesh 512 and the door 514 is (independently) removably insertable into the cavity 510. The mesh 512, when inserted into the cavity 510, covers the openings 508 and, due to its permeability, allows liquid to flow through the openings 508. The door 514, when inserted into the cavity 510, blocks liquid flow through the openings 508.

The pan 500 (of FIGS. 5A, 5B, and 5C) is similar to the skillet 200 (of FIGS. 2A and 2B). Thus, the components of the pan 500 operate (e.g., to drain liquid) and relate to one another in a similar manner as is described with respect to the skillet 200 (of FIGS. 2A and 2B); the description is not repeated here only for brevity. Some differences include that the sidewall is vertical on the pan 401 (while the sidewall is non-vertical on the skillet 200); and the pan 500 has cavities into which the meshes and the doors are removably insertable (while the mesh is located on an inside of the skillet 200 and the door is located on an outside of the skillet 200).

Each door is moveable between an open position and a closed position. Each door is configured to selectively block liquid drainage through the corresponding openings (i.e., based on being in the open position or the closed position). FIG. 5B illustrates each of the doors 514 and 516 in the closed position. FIG. 5C illustrates the door 514 in the closed position and the door 516 in the open position.

The door 514 (i.e., a first door) comprises a plate 514a and a tab 514b extending from the plate. The plate 514a of the door 514 is configured to block the openings 508 when fully inserted into the cavity 510. The tab 514b facilitates moving (e.g., sliding within the cavity 510) the door 514 between the open position and the closed position. For example, a force applied to the tab 514b in a vertical axis can moves the door 514 from the open position to the closed position. The door 514 simultaneously closes/reveals the openings 508 while moving. In the closed position, the plate 514a covers all of the openings 508 to prevent the liquid from escaping through the openings 508. The plate 514a is solid (i.e., unbroken and lacks perforations) and spans across the openings 508 to fully block all of the openings 508 in the closed position. In the open position, the plate 514a exposes all of the openings 508 to allow the liquid to escape through the openings 508.

The door 516 (i.e., a second door) comprises a plate 516a and a tab 516b extending from the plate. The plate 516a of the door 516 is configured to block the openings 522 when fully inserted into the cavity 520. The tab 516b facilitates moving (e.g., sliding within the cavity 520) the door 516 between the open position and the closed position. For example, a force applied to the tab 516b in a vertical axis can moves the door 516 from the open position to the closed position. The door 516 simultaneously closes/reveals the openings 522 while moving. In the closed position, the plate 516a covers all of the openings 522 to prevent the liquid from escaping through the openings 522. The plate 516a is solid (i.e., unbroken and lacks perforations) and spans across the openings 522 to fully block all of the openings 522 in the closed position. In the open position, the plate 516a exposes all of the openings 522 to allow the liquid to escape through the openings 522.

The doors on a skillet are independently operable. In the example of pan 500, the door 514 can remain open (and/or partially open) while the door 516 is closed and vice versa. A user may choose which of the doors to open based on a door being aligned in a direction of tilt that is most comfortable given their handedness (e.g., left-handed or right-handed). Moreover, both doors can be open to quickly drain liquid from both sides of the pan 500. Both doors can be closed to prevent liquid from draining from the pan 500 (e.g., while cooking). The meshes on a skillet are similarly independently operable.

Turning to FIG. 5C, FIG. 5C is a section through the pan 500. The door 514 is in a closed position, which prevents liquid from draining through the opening 508b (and others of the openings 508) as generally indicated by a directional arrow 526. The door 516 is in an open position, which allows liquid to drain through the opening 522b (and others of the openings 522) as generally indicated by a directional arrow 524. The liquid passes through the mesh 518 as it drains through the opening 522b. The mesh 518 prevents some solids (i.e., solids larger than a pore size of the mesh) from passing through the mesh 518 and, thereby, prevents those solids from draining out of the pan 500.

Each of the openings 522 and 508 opening is provided in a lower portion of the sidewall 502 in close proximity to the cooking surface 504a. The tilt angle required to drain the skillet decreases as (e.g., as a function of) the opening moves closer to the cooking surface. Thus, the lower the angle of tilt desired for the cooking vessel, the lower the opening is provided in the sidewall (e.g., a lower 50%, 25%, 20%, or 10% of a depth of the pan 500). The depth of the skillet is labeled d in FIG. 5C. The 0.5d elevation mark corresponds to the lower 50% of the depth of the pan 500. The 0.25d elevation mark corresponds to the lower 25% of the depth of the pan 500. The 0.1d elevation mark corresponds to the lower 10% of the depth of the pan 500. Each of the openings 522 and 508 is collinear with the cooking surface 504a (as is illustrated in FIG. 5C) to achieve a minimum tilt angle for drainage. In this example, the cooking surface 504a is flat; a bottom (e.g., a lowest point) of each of the openings 522 and 508 lies on the same straight line as the cooking surface 504a. Because each of the openings 522 and 508 are collinear with the cooking surface 504a, the liquids drain out of the pan 500 directly from the cooking surface 504a. The liquid does not travel over the sidewall 502 and instead travels only laterally (along the cooking surface) to escape the pan 500 through/under sidewall 502. In other examples, a circular or ovular opening being collinear with the cooking surface 504a may comprise the cooking surface 504a being tangential to the circular or ovular opening.

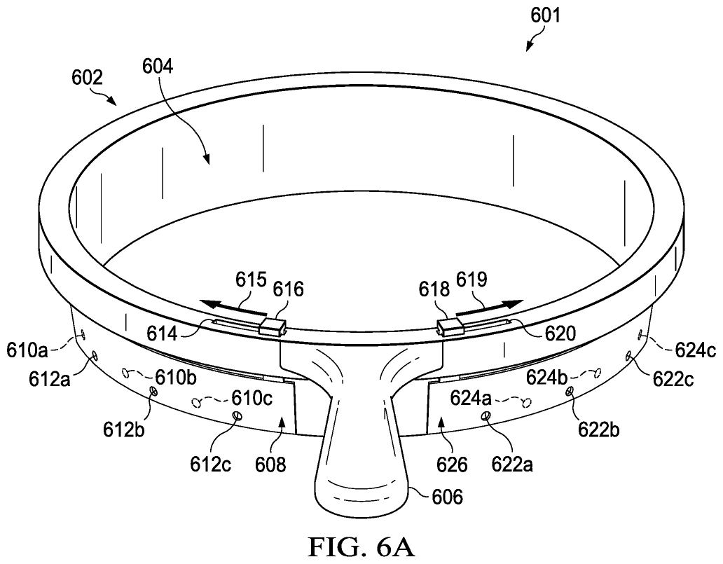

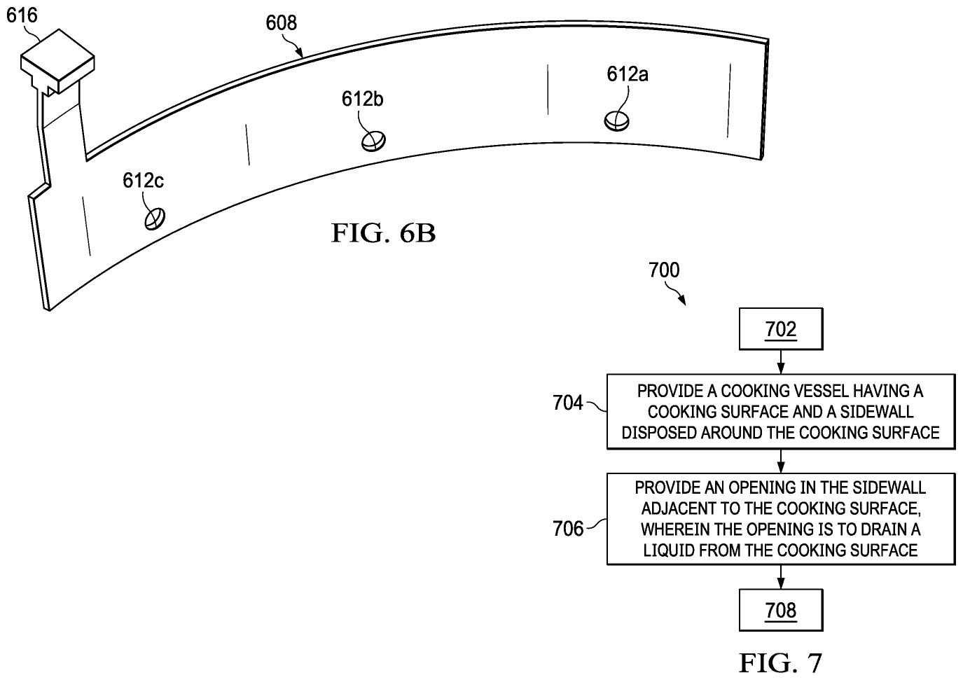

FIG. 6A illustrates a cooking vessel (pan 601) with multiple openings adjacent to each side of a handle for drainage, according to an embodiment of the present disclosure. The pan 601 comprises a base wall 604 and a sidewall 602 extending from the base wall 604. A top surface of the base wall is a cooking surface configured to transmit heat to foodstuffs. A handle 606 is coupled to the sidewall 602. The sidewall includes openings 610a, 610b, and 610c (referred to collectively as openings 610) on one side of the handle 606 and includes openings 624a, 624b, and 624c (referred to collectively as openings 624) on an opposite side of the handle 606. The openings are circular in shape. Each of the openings is configured to drain a liquid from the cooking surface based on being adjacent to the cooking surface. The openings are located within a threshold distance of the cooking surface (e.g., within 25 percent of a depth of the pan 601). The openings are collinear with the cooking surface (i.e., the cooking surface is tangential to a point on the circular shape of the opening).

Doors 608 and 626 are to selectively block the openings 610 and the openings 624 respectively. The door 608 comprises openings 612a, 612b, and 612c (referred to collectively as openings 612). The openings 612 are circular in shape and correspond to a size and spacing of the circular openings 610 in the sidewall. A tab 616 is attached to the door 608. The door 626 comprises openings 622a, 622b, and 622c (referred to collectively as openings 622). The openings 622 are circular in shape and correspond to a size and spacing of the circular openings 624 in the sidewall. A tab 618 is attached to the door 626.

The tabs 616 and 618, at least in part, attach the doors 608 and 626, respectively, to the pan 601. Each of the tabs 616 and 618 is stepped, in shape, to facilitate supporting the doors in openings in the edge of the sidewall (as shown in FIG. 6A). FIG. 6A shows an outer side of the door 6A; FIG. 6B shows an inner side of the door 608. FIG. 6B also illustrates the stepped shape of the tab 616; the narrow portion of the tab 616 (the lower portion) fits within the opening 614; the wide portion of the tab 616 (the upper portion) rests atop the edge of the sidewall 602. The tab 618 has a stepped shape matching that of the tab 616. The doors 608 and 626 attach to the skillet based, at least in part, on the tabs 616 and 618 being embedded in the edge of the skillet (as shown in FIG. 6A). A further attachment mechanism may attach each of the doors 608 and 626 to the outside surface of the sidewall 602 (e.g., a track). The tabs 616 and 618 also facilitate moving the doors 608 and 626 between an open position and a closed position. For example, moving the tab 616 in a direction 615 moves the door 608 from the closed position (as shown) toward the open position; moving the tab 618 in a direction 619 moves the door 626 from the closed position (as shown) toward the open position. The tabs 616 and 618 slide within the openings 614 and 620, respectively, while moving the doors between the open position and the closed position. Each of the doors 608 and 626 is independent operable to move between the open and the closed positions.

FIG. 6B shows each of the doors 608 and 626 in the closed position. In the closed position, the door 608 blocks the openings 610 and the door 626 blocks the openings 624 to prevent liquid from draining from the pan 601. The doors block the openings in the sidewall based on the openings in the door being intentionally misaligned with the openings in the sidewall when in the closed position. In the open position, each of the doors 608 and 626 exposes all of the openings 610 and the openings 624, respectively, to allow the liquid to drain from the pan 601. The doors reveal the openings in the sidewall based on the openings in the door being aligned with the openings in the sidewall when in the open position.

Advantageously, a user may drain liquid from the pan 601 using only one hand. The liquid can drain from the pan 601 at a low tilt angle. The low tilt angle needed to drain the liquid from the openings 610 and 624 avoids the need to use the lid (and a second hand hold the lid) to prevent the foodstuffs from falling out. Moreover, the tabs 616 and 618 being in close proximity to the handle 606 enables opening and/or closing each of the doors using only one hand. For example, a thumb or other digit can reach at least one of the tabs while the other digits on the same hand are wrapped around the handle 606. A user may choose which of the doors to open based on a door being aligned in a direction of tilt that is most comfortable given their handedness (e.g., left-handed or right-handed).

Turning to FIG. 7, FIG. 7 illustrates a method 700 for providing a cooking vessel configured to drain liquid, according to an embodiment of the present disclosure. The method 700 begins at 702, which may coincide with a start/end point of other methods. The method 700 advances from 702 to 704, where a cooking vessel having a cooking surface and a sidewall disposed around the cooking surface is provided. Such provisioning of the cooking vessel may comprise manufacturing, assembling, pressing, casting, and/or otherwise generating the cooking vessel. In some examples, the cooking vessel is received (e.g., from another entity). At 706, an opening is provided in the sidewall to facilitate draining a liquid from the cooking surface. Multiple openings may be provisioned. Such provisioning of the opening may include punching, drilling, milling, removing material, or otherwise creating a void in the sidewall to generate the opening in the sidewall of the cooking vessel. In some embodiments, 704 and 706 are executed substantially simultaneously, e.g., where the cooking vessel is formed by a single machine that also creates the openings. The opening (or openings) may be provided in a lower portion of the sidewall (adjacent to the cooking surface) to configure the cooking vessel for draining liquid from the cooking surface at a low tilt angle. For example, a portion of the opening may be provisioned in lowest half of a depth of the cooking vessel. In general, the tilt angle needed to drain liquid from the cooking vessel decreases as the opening is moved closer to the cooking surface. Thus, the lower the angle of tilt desired for the cooking vessel, the lower the opening is provided in the sidewall (e.g., a lower 50%, 25%, 20%, or 10% of the depth of the cooking vessel). The method may further comprise provisioning a door to selectively block the liquid from draining through the opening and/or provisioning a mesh to filter solids from the liquid draining through the opening. The method may further comprise draining liquid from the cooking surface out of the cooking vessel through the opening. The cooking vessel may be any of the various cooking vessel described in the present disclosure (e.g., 100, 200, 301, 401, 500, and/or 601). The method 700 may or may not end at 708, which may coincide with a start/end point of other methods.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In terms of the dimensions of the articles discussed herein (e.g., cooking vessels, pans, skillets, pots, openings, doors, meshes, tabs, etc.), any suitable specifications (e.g., width, depth, height, thickness, etc.) may be used and can be based on particular end user needs, or specific elements to be addressed by the apparatus (or the system in which it resides). It is imperative to note that all of the specifications and relationships outlined herein (e.g., width, depth, height, thickness, number of recessions, number of openings, number of pairs of openings, number of sets of openings, number of meshes, number of doors, shape of openings, shape of doors, shape of cooking vessels, etc.) have only been offered for purposes of example and teaching only. Each of these data may be varied considerably without departing from the spirit of the present disclosure, or the scope of the appended claims. The specifications apply only to non-limiting examples and, accordingly, should be construed as such. Along similar lines, the materials used in constructing the articles can be varied considerably, while remaining within the scope of the present disclosure.

Moreover, the elements described herein may be made of any suitable materials, including metal (e.g., stainless steel, copper, tin, silver, brass, cast iron, enamel covered cast iron, aluminum, nickel, alloy, etc.), terra cotta, fired clay, ceramic, glass, stone, BAKELITE, or any suitable combination thereof. Each element may also be made of a combination of different materials (e.g., a sidewall may be made of stainless steel with a brass rim; a sidewall and a base wall may be made of cast iron with a ceramic coating; a handle may be made, in part of, metal with a BAKELITE housing, etc.). Any suitable material or combination of materials may be used for the elements described herein without departing from the broad scope of the present disclosure.

In certain implementations and numerous examples provided herein, openings are described in reference to a cooking vessel. The openings of the present disclosure, however, are not limited to such vessel, but can be applied to a myriad of other types of containers (e.g., soup bowls, tea pots, paint containers, dry food containers, etc.). It will be appreciated that the broad teachings disclosed herein are intended to include any type of containers that can be used, for example, to separate liquids and solids from the containers.

In addition, the shapes shown and illustrated in the various FIGURES are for example purposes only. Various other shapes may be used herein without changing the scope of the present disclosure.

It will be appreciated that substantial flexibility is provided by the system in that any suitable arrangements and configurations may be provided without departing from the teachings of the discussed concepts. Although the present disclosure has been described in detail with reference to particular arrangements and configurations, these example configurations and arrangements may be changed significantly without departing from the scope of the present disclosure. For example, some embodiments of the present disclosure are described with reference to cooking vessels; the teachings of the present disclosure are applicable to other types of containers.

While the disclosure references several particular embodiments, those skilled in the art will be able to make various modifications to the described embodiments without departing from the true spirit and scope of the disclosure. It is intended that all elements or steps, which are insubstantially different from those, recited in the claims but perform substantially the same functions, respectively, in substantially the same way to achieve the same result as what is claimed are within the scope of the disclosure.

Additionally, it should be noted that with the examples provided above, interaction may be described in terms of one, two, three, or four openings, doors, and/or meshes. However, this has been done for purposes of clarity and example only. In certain cases, it may be easier to describe one or more of the functionalities of a given set of flows by only referencing a limited number of openings, doors, and/or meshes. It should be appreciated that the cooking vessels described herein are readily scalable and, further, can accommodate a larger number of openings, doors, and/or meshes, as well as more complicated/sophisticated arrangements and configurations of openings through which to drain liquids.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A cooking vessel comprising:
a base wall comprising a cooking surface configured to transmit heat to foodstuffs;
a sidewall extending from the base wall; and
at least one opening in the sidewall adjacent to the cooking surface, wherein the at least one opening is configured to drain a liquid from the cooking surface based on being adjacent to the cooking surface.

2. The cooking vessel of claim 1, wherein the at least one opening in the sidewall being adjacent to the cooking surface comprises the at least one opening lying within a lowest 50 percent of a depth of the cooking vessel.

3. The cooking vessel of claim 1, wherein the at least one opening in the sidewall being adjacent to the cooking surface comprises a portion of the at least one opening being collinear with the cooking surface.

4. The cooking vessel of claim 1, wherein the at least one opening is fully contained within 1 centimeter of the cooking surface.

5. The cooking vessel of claim 1, further comprising:
a door movable between an open position and a closed position, where the door covers the at least one opening in the closed position and the door exposes the at least one opening in the open position.

6. The cooking vessel of claim 5, wherein the door in the closed position is configured to prevent the liquid from escaping through the sidewall and wherein the door in the open position is configured to allow the liquid to escape through the sidewall.

7. The cooking vessel of claim 5, wherein the door comprises recessions and/or openings, the recessions and/or the openings corresponding to the at least one opening.

8. The cooking vessel of claim 1, further comprising:
a mesh configured to cover the at least one opening, the mesh being permeable to liquids, and wherein the mesh member is configured to allow the liquid to pass through the at least one opening and to prevent solid portions of the foodstuffs from passing through the at least one opening.

9. The cooking vessel of claim 1, wherein the at least one opening being configured to drain the liquid from the cooking surface based on being adjacent to the cooking surface comprises:
the at least one opening being configured to drain the liquid from the cooking surface based on the cooking vessel being tilted at an angle of about 10 degrees or less.

10. The cooking vessel of claim 1, wherein a highest 50% of the depth of the cooking vessel is imperforate.

11. The cooking vessel of claim 1, wherein the base wall further comprises a heating surface configured to receive the heat from a flame and/or a heat producing surface.

12. The cooking vessel of claim 11, wherein the entirety of the base wall is solid and lacks perforations.

13. The cooking vessel of claim 1, wherein a height of the cookware is less than or equal to one third of a depth of the cookware.

14. A system comprising:
a skillet comprising:
a base wall comprising a cooking surface configured to transmit heat to foodstuffs;
a sidewall extending from the base wall,
an opening in the sidewall within a lowest 25 percent of a depth of the cooking vessel relative to the cooking surface, wherein the opening is configured to drain a liquid from the cooking surface based on being adjacent to the cooking surface, and
a handle coupled to the sidewall; and
a door comprising a tab embedded in an edge of the sidewall adjacent to the handle, wherein the tab facilitates moving the door between an open position and a closed position, and wherein the door covers the opening in the closed position and the door exposes the opening in the open position.

15. The system of claim 14, wherein the opening being adjacent to the cooking surface comprises a portion of the opening being collinear with the cooking surface.

16. The system of claim 14, further comprising a mesh insert configured to filter solids from the liquid, the mesh insert comprising a handle configured for attaching and removing the mesh insert and the skillet.

17. The system of claim 16, wherein the tab is configured to lock in place the handle of the mesh when the door is in the open position.

18. A method comprising:
providing a cooking vessel having a cooking surface and a sidewall disposed around the cooking surface; and
providing an opening in the sidewall adjacent to a cooking surface, wherein the opening is to drain a liquid from the cooking surface.

19. The method of claim 18, further comprising:
tilting the cooking vessel at an angle of about 10 degrees or less; and
draining the liquid from the cooking surface through the opening based on being adjacent to the cooking surface and the cooking vessel being tilted at the angle of about 10 degrees or less.

20. The method of claim 18, wherein the providing the opening in the sidewall adjacent to the cooking surface comprises:
the opening being provided within a threshold distance of the cooking surface, the threshold being equal to 25% of a depth of the cooking vessel and being measured perpendicular to the cooking surface.
